(19) United States
(12) Patent Application Publication
(10) Pub. No.: US 2025/0350102 A1
(43) Pub. Date: Nov. 13, 2025

(54) WIRE PULLER FOR EASILY CHANGING WIRES

(71) Applicant: Kuei-Kun WU, Kaohsiung (TW)

(72) Inventor: Kuei-Kun WU, Kaohsiung (TW)

(21) Appl. No.: 18/662,335

(22) Filed: May 13, 2024

(51) Int. Cl. H02G 1/08

(52) U.S. Cl. CPC H02G 1/081

(57) ABSTRACT

A wire puller handle for easily changing wires includes a main frame, a take-up wheel, a plurality of fasteners, and a spring tube. The main frame includes a stand, a handle, a fixing shaft, and a fixing bracket. The take-up wheel includes a first half-wheel frame and a second half-wheel frame. A winding area is defined between the first half-wheel frame and the second half-wheel frame for accommodating a pull wire, and the take-up wheel performs free rotation by sleeving the sleeve on the fixing shaft. The plurality of fasteners are respectively fixed to the first half-wheel frame and the second half-wheel frame. The spring tube is passed and fixed to the fixing bracket at one end; the other end thereof is provided for the other end of the pull wire being sent out or retracted when the take-up wheel is in free rotation.

### FIELD OF THE INVENTION

The invention relates to a wire puller, and more particularly to a wire puller for easily changing wires.

### BACKGROUND OF THE INVENTION

Please refer to FIG. 1, a wire puller 1 includes a metal bracket 11, a take-up wheel 12 and a spring tube 13. The metal bracket 11 includes a shaft 111, a handle 112 connected to the shaft 111 and close to one end thereof, and a bottom base 113 connected to the other end of the shaft 111. The bottom base 113 includes two base frames 114 and a fixing part 115, wherein the two base frames 114 stand at two ends of the shaft 111, and the fixing part 115 is fixed to the end of the shaft 111 not being connected to the handle 112. An inner space 116 is formed by the fixing part 115 fixing the two base frame 114 to the shaft 111, and the fixing part 115 is provided with a guide rod 117 above. The take-up wheel 12 is axially connected to the inner space 116. The take-up wheel 12 includes a wheel frame 121 integrally formed, and a sleeve 122 connected to a side of the wheel frame 121. An interior of the wheel frame 121 is provided with a winding area 1211 corresponding to a pull wire 14, and one end of the pull wire 14 is fixed in the wheel frame 121, the sleeve 122 is sleeved on the shaft 111, so that the take-up wheel 12 performs free rotation. One end 131 of the spring tube 13 is passed through and fixed to one end of the guide rod 117, the pull wire 14 of the take-up wheel 12 passes from one end 131 of the spring tube 13 to the other end 132 of the spring tube 13 for being sent out or retracted.

In a construction site, the wheel frame 121 is integrally formed and cannot be immediately disassembled to replace the pull wire 14 with different types of wires or lengths, that is, the pull wire 14 in the wheel frame 121 is required to pull out first, and replaces a required pull wire 14 and be retracted into the wheel frame 121, which is troublesome and inconvenient to replace. Therefore, in order to save the time of replacing the pull wire 14, an operator must prepare multiple sets of the pull wire 14 of wire pullers 1 with different specifications, wire types, and lengths, and the metal bracket 11 of each set of the wire puller 1 is large in volume and has considerable weight, causing inconvenience in carrying.

### SUMMARY OF THE INVENTION

A main object of the invention is to provide a wire puller for easily changing wires, and an operator can easily change the pull wire with different specifications, wire types, and the lengths.

In order to achieve the above object, the invention provides a wire puller for easily changing wires including a main frame, a take-up wheel, a plurality of fasteners, and a spring tube. The main frame includes a stand, a handle connected to the stand, a fixing shaft arranged horizontally between the stand and the handle, and a fixing bracket configured at a side of the fixing shaft. The take-up wheel includes a first half-wheel frame with a sleeve, and a second half-wheel frame correspondingly assembled with the first half-wheel frame, wherein a winding area is defined in an interior between the first half-wheel frame and the second half-wheel frame, and the winding area is provided for accommodating a pull wire, and one end of the pull wire is fixed to the take-up wheel, and wherein the take-up wheel is configured to perform free rotation by sleeving the sleeve on the fixing shaft. The plurality of fasteners are respectively fixed to the first half-wheel frame and the second half-wheel frame. The spring tube is passed and fixed to the fixing bracket at one end and the other end of the spring tube is provided for the other end of the pull wire being sent out or retracted when the take-up wheel is in free rotation. The pull wire is easy to be changed by disassembling or assembling the plurality of fasteners and the second half-wheel frame.

Further, the first half-wheel frame includes a first outer ring and a first inner ring. A diameter of the first inner ring is smaller than that of the first outer ring, and the first inner ring is located within a diameter range of the first outer ring, and the first inner ring is arranged on a horizontal plane different from the first outer ring. The sleeve is connected to a side of a first inner ring and protrudes toward the second half-wheel frame, and the sleeve is formed with a protruding block at an end opposite to the first inner ring. The protruding block, the first inner ring, and the sleeve are communicated in hollow. The first half-wheel frame further comprises a plurality of first arc-shaped rods between the sleeve and the first outer ring, and the plurality of first arc-shaped rods are round rods, one end of each of the plurality of first arc-shaped rods fixed to one end of the sleeve, and an other end of each of the plurality of first arc-shaped rods fixed to the first outer ring. The second half-wheel frame comprises a second outer ring and a second inner ring, and a diameter of the second inner ring is smaller than that of the second outer ring, and the second inner ring is located within a diameter range of the second outer ring, and the second inner ring is arranged on a horizontal plane different from the second outer ring. The second half-wheel frame further comprises a plurality of second arc-shaped rods between the second inner ring and second outer ring and corresponding to the plurality of first arc-shaped rods, and the plurality of second arc-shaped rods are round rods, and one end of each of the plurality of second arc-shaped rods fixed to the second inner ring, and an other end of each of the plurality of second arc-shaped rods fixed to the second outer ring.

Further, the first half-wheel frame comprises a first fixing sleeve fixed to one of the plurality of first arc-shaped rods for fixing one end of the pull wire.

Further, the second half-wheel frame comprises a second fixing sleeve and a plurality of buckles, the second fixing sleeve is fixed to the second outer ring for fixing the other end of the pull wire while not being used, and the plurality of buckles are respectively fixed to the second outer ring.

Further, each of the plurality of fasteners includes a plurality of embedded parts and a guide part. The plurality of embedded parts are arranged on an outer surface of the fastener and spaced apart. Each of the plurality of embedded parts comprises an embedded slot and two fastening bodies respectively protruding from two sides of each of the plurality of embedded parts toward the embedded slot, and one of the plurality of first arc-shaped rods and one of the plurality of second arc-shaped rods are respectively fastened into one of the plurality of embedded parts. The guide part is arranged on an inner surface of each of the plurality of fasteners, and the guide part comprises a curved section and two inclined sections respectively extending from the curved section to two ends of each of the plurality of fasteners.

Further, the plurality of fasteners are respectively arranged in different directions to fasten each of the plurality of first arc-shaped rods and each of the plurality of second arc-shaped rods.

Further, the plurality of fasteners are made of plastic material.

Further, the stand includes two support poles inclined and spaced apart, and a crossbar connected to bottoms of the two support poles. The fixing shaft comprises a shaft tube, a screw hole configured between the stand and the handle and provided for engagement with one end of the shaft tube, and a fixing rotation piece engaged with the other end of the shaft tube opposite to the screw hole. The shaft tube comprises a first outer thread for engaging with the screw hole, and a second outer thread for engaging with an inner thread of the fixing rotation piece.

Further, the fixing shaft comprises two locking members, and each of the two locking members comprises an inner thread for engaging with the second outer thread of the shaft tube, one end of in the fixing bracket hung and fixed between the two locking members on the second outer thread of the shaft tube, and an other end of the fixing bracket comprises an annular portion configured obliquely, and the annular portion comprises a through hole.

Further, the annular portion further comprises a first protection washer and a second protection washer assembled with the first protection washer, and wherein the first protection washer is hollow, and one end of the first protection washer passes the through hole to be assembled with the second protection washer.

Through the foregoing implementation of the invention, compared with the prior art, the invention has the following characteristics: the take-up wheel performs free rotation by sleeving the sleeve on the fixing shaft so as to send out or retract the other end of the pull wire from the other end of the spring tube, and the second half-wheel frame is assembled or disassembled with the first half-wheel frame by the plurality of fasteners so that the pull wire is easily changed with different specifications, wire types, and lengths, that is, the wire puller of the invention is easy to change the pull wire and convenient to carry thereof.

### BRIEF DESCRIPTION OF THE DRAWINGS

FIG. 1 is a perspective view of a conventional wire puller.

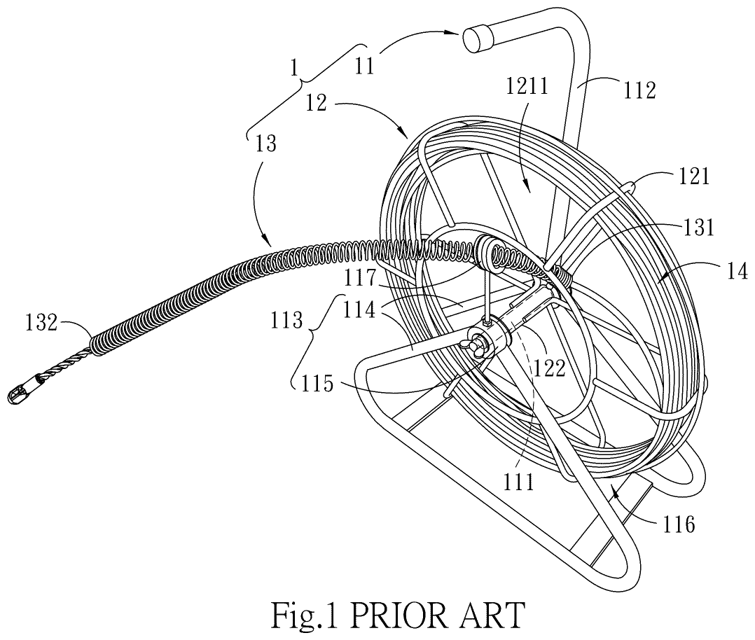

FIG. 2 is an exploded perspective view of a wire puller of the invention.

FIG. 3 is a perspective view of a combination of the wire puller and a spring tube of the invention.

FIG. 4 is a cross-sectional view of a side view of the wire puller in FIG. 3.

FIG. 5 is a cross-sectional view of a plurality of fasteners fastening a first arc-shaped long rod in FIG. 4.

FIG. 6 is a perspective schematic diagram of the wire puller changing a pull wire in FIG. 3.

### DETAILED DESCRIPTION OF THE PREFERRED EMBODIMENTS

The detailed description and technical content of the invention are described below with reference to the accompanying drawings.

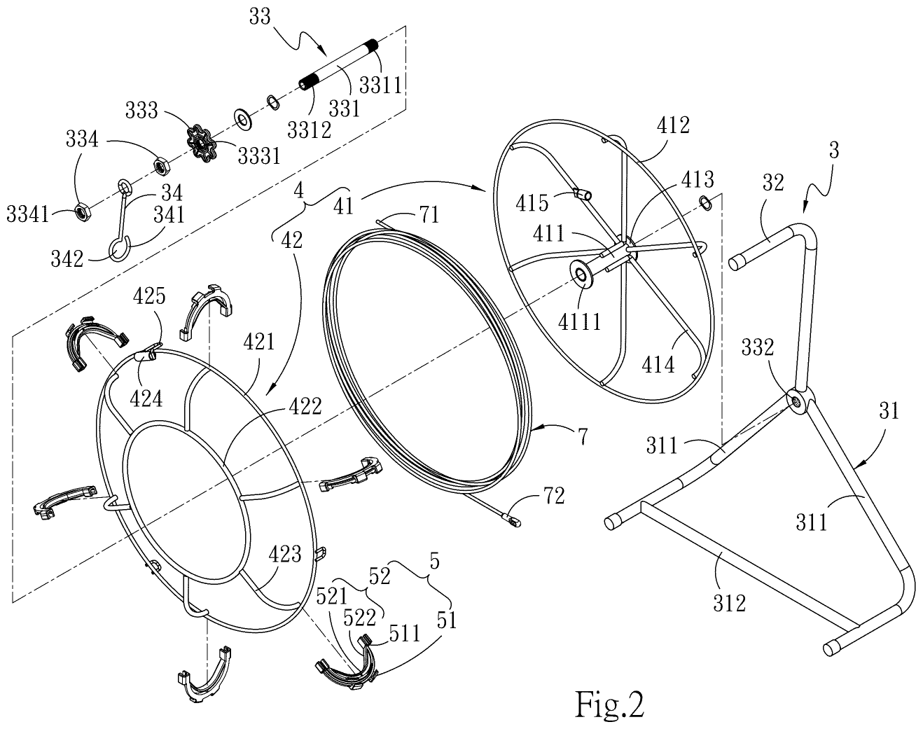

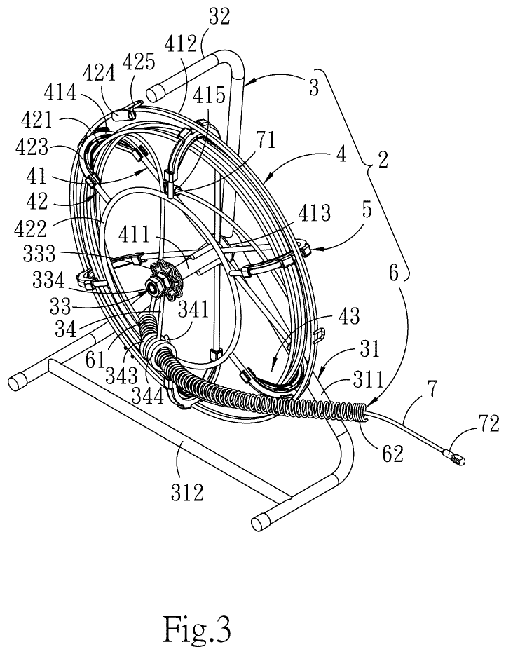

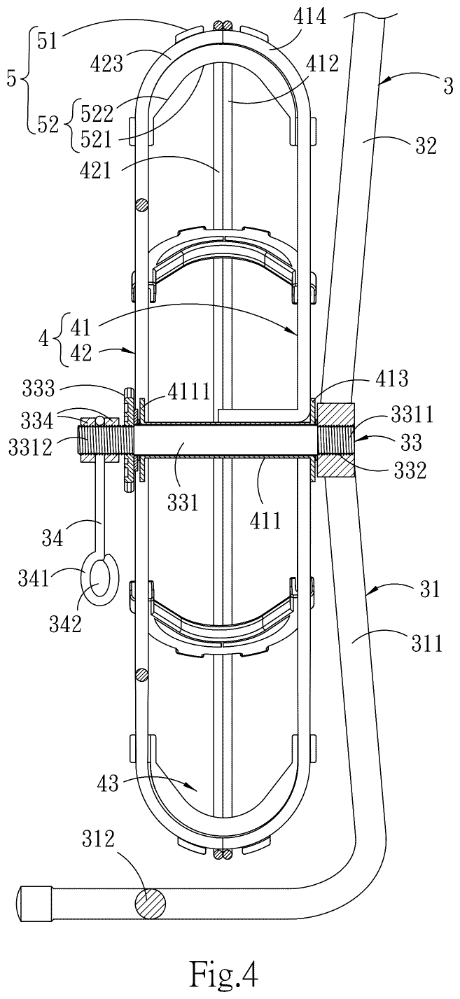

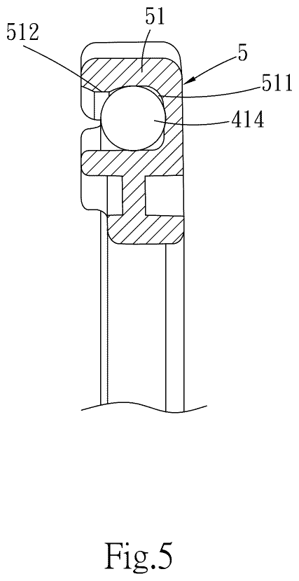

Please refer to FIG. 2, FIG. 3, FIG. 4, and FIG. 5. The invention provides a wire puller 2 for easily changing wires, including a main frame 3, a take-up wheel 4, a plurality of fasteners 5, and a spring tube 6.

The main frame 3 includes a stand 31, a handle 32 connected to the stand 31, a fixing shaft 33 arranged horizontally between the stand 31 and the handle 32, and a fixing bracket 34 configured at a side of the fixing shaft 33. In practical structure, the stand 31 includes two support poles 311 inclined and spaced apart, and a crossbar 312 connected to bottoms of the two support poles 311. The fixing shaft 33 includes a shaft tube 331, a screw hole 332 configured between the stand 31 and the handle 32 and provided for engagement with one end of the shaft tube 331, and a fixing rotation piece 333 engaged with the other end of the shaft tube 331 opposite to the screw hole 332. In detail, the shaft tube 331 is provided with a first outer thread 3311 for engaging with the screw hole 332, and a second outer thread 3312 for engaging with an inner thread 3331 of the fixing rotation piece 333.

The fixing shaft 33 further includes two locking members 334, and each of the two locking members 334 is provided with an inner thread 3341 for engaging with the second outer thread 3312 of the shaft tube 331. One end of the fixing bracket 34 is hung and fixed between the two locking members 334 on the second outer thread 3312 of the shaft tube 331, and the other end of the fixing bracket 34 is provided with an annular portion 341 configured obliquely, and the annular portion 341 includes a through hole 342.

The annular portion 341 further includes a first protection washer 343 and a second protection washer 344 assembled with the first protection washer 343. The first protection washer 343 is hollow, and one end of the first protection washer 343 passes the through hole 342 to be assembled with the second protection washer 344, and one end 61 of the spring tube 6 penetrates into the annular portion 341 from the first protection washer 343.

The take-up wheel 4 includes a first half-wheel frame 41 with a sleeve 411, and a second half-wheel frame 42 correspondingly assembled with the first half-wheel frame 41. A winding area 43 is defined in an interior between the first half-wheel frame 41 and the second half-wheel frame 42, and the winding area 43 is provided for accommodating a pull wire 7. In an embodiment, the take-up wheel 4 performs free rotation by sleeving the sleeve 411 on the fixing shaft 33, and the take-up wheel 4 is limited to not fall out from the second outer thread 3312 of the shaft tube 331 by the fixing rotation piece 333 during free rotation. The first half-wheel frame 41 further includes a first outer ring 412 and a first inner ring 413, wherein a diameter of the first inner ring 413 is smaller than that of the first outer ring 412, and the first inner ring 413 is located within a diameter range of the first outer ring 412, and the first inner ring 413 is arranged on a horizontal plane different from the first outer ring 412. The sleeve 411 is connected to a side of a first inner ring 413 and protrudes toward the second half-wheel frame 42, the sleeve 411 is formed with a protruding block 4111 at an end opposite to the first inner ring 413. The protruding block 4111, the first inner ring 413, and the sleeve 411 are communicated in hollow.

Further, the first half-wheel frame 41 is provided with a plurality of first arc-shaped rods 414 between the sleeve 411 and the first outer ring 412. The plurality of first arc-shaped rods 414 are round rods, and one end of each of the plurality of first arc-shaped rods 414 is fixed to one end of the sleeve 411, and the other end of each of the plurality of first arc-shaped rods 414 is fixed to the first outer ring 412, thereby the first half-wheel frame 41 is supported by the plurality of first arc-shaped rods 414. The first half-wheel frame 41 further includes a first fixing sleeve 415 fixed to one of the plurality of first arc-shaped rods 414 for fixing one end 71 of the pull wire 7 without slipping off.

The second half-wheel frame 42 includes a second outer ring 421 and a second inner ring 422, wherein a diameter of the second inner ring 422 is smaller than that of the second outer ring 421, and the second inner ring 422 is located within a diameter range of the second outer ring 421, and the second inner ring 422 is arranged on a horizontal plane different from the second outer ring 421. The second half-wheel frame 42 is provided with a plurality of second arc-shaped rods 423 between the second inner ring 422 and the second outer ring 421 and corresponding to the plurality of first arc-shaped rods 414. The plurality of second arc-shaped rods 423 are round rods, and one end of each of the plurality of second arc-shaped rods 423 is fixed to the second inner ring 422, and the other end of each of the plurality of second arc-shaped rods 423 is fixed to the second outer ring 421, thereby the second half-wheel frame 42 is supported by the plurality of second arc-shaped rods 423. The second half-wheel frame 42 further includes a second fixing sleeve 424 and a plurality of buckles 425, the second fixing sleeve 424 is fixed to the second outer ring 421 for fixing the other end 72 of the pull wire 7 while not being used. The plurality of buckles 425 are respectively provided on the second outer ring 421 to fix the first half-wheel frame 41 and the second half-wheel frame 42, thereby enhancing an assembly stability of the first half-wheel frame 41 and the second half-wheel frame 42. In one embodiment, the plurality of buckles 425 are located between the plurality of second arc-shaped rods 423. In addition, forms and numbers of the plurality of buckles 425 can be changed according to needs.

The plurality of fasteners 5 are made of plastic material. Taking one fastener 5 as an illustration as follows. The fastener 5 includes a plurality of embedded parts 51 and a guide part 52. The plurality of embedded parts 51 are arranged on an outer surface of the fastener 5 and spaced apart, wherein each of the plurality of embedded parts 51 includes an embedded slot 511 and a fastening body 512 protruding from one side of the embedded part 51 toward the embedded slot 511, and one of the plurality of first arc-shaped rods 414 and one of the plurality of second arc-shaped rods 423 are respectively fastened into one of the plurality of embedded parts 51 through the two fastening bodies 512. The guide part 52 is arranged on an inner surface of the fastener 5 facing the second outer ring 421 for the pull wire 7 to be guided into position, wherein the guide part 52 includes a curved section 521 and two inclined sections 522 respectively extending from the curved section 521 to two ends of the fastener 5. The pull wire 7 in the winding area 43 is guided into the fastener 5 through the two inclined sections 522 for positioning. In an embodiment, the plurality of fasteners 5 are respectively arranged in different directions to fasten each of the plurality of first arc-shaped rods 414 and each of the plurality of second arc-shaped rods 423 so that the first half-wheel frame 41 and the second half-wheel frame 42 are engaged more securely.

Please refer to FIG. 2, FIG. 3, FIG. 4, and FIG. 5. In an embodiment, one end 71 of the pull wire 7 is fixed to the first fixing sleeve 415 in the winding area 43, one end 61 of the spring tube 6 penetrates obliquely from the through hole 342 to the winding area 43, and the other end 72 of the pull wire 7 passes from one end 61 to the other end 62 of the spring tube 6. During operation, an operator holds the other end 62 of the spring tube 6 with one hand, and holds the other end 72 of the pull wire 7 with the other hand to pull back or push forward, the take-up wheel 4 performs free rotation by sleeving the sleeve 411 on the fixing shaft 33 so as to send out or retract the other end 72 of the pull wire 7 from the other end 62 of the spring tube 6.

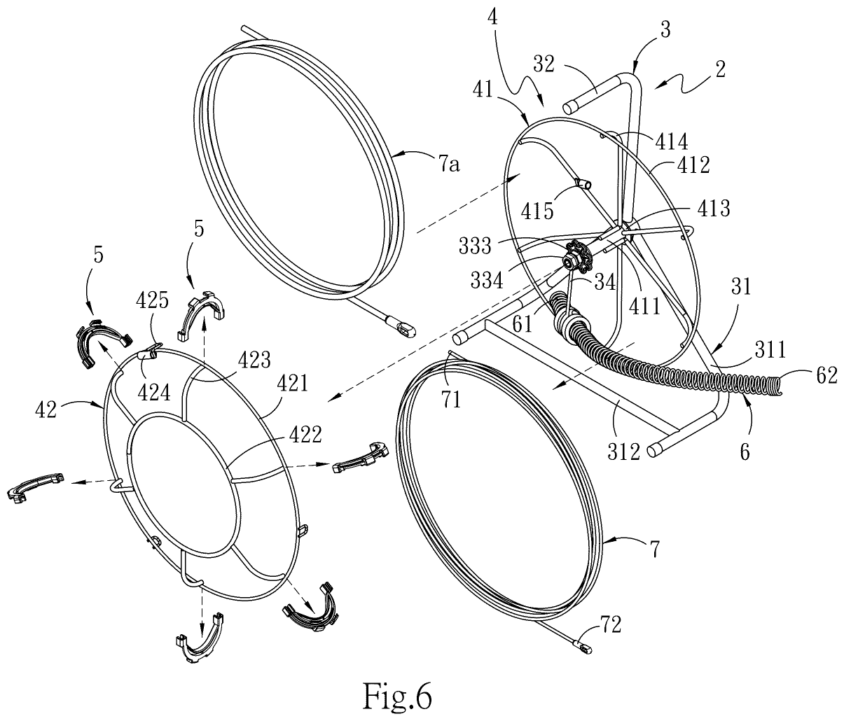

Please refer to FIG. 6, when the operator changes the pull wire 7 at the construction site, the plurality of fasteners 5 are firstly disassembled, and the second half-wheel frame 42 is separated from the first half-wheel frame 41, and the pull wire 7 can be changed with different specifications, wire types and lengths, then the second half-wheel frame 42 is reassembled with the first half-wheel frame 41, the plurality of fasteners 5 are respectively engaged with one of the plurality of first arc-shaped rods 414 and one of the plurality of second arc-shaped rods 423. The wire puller of the invention is easy to change the pull wire and convenient to carry thereof.

What is claimed is:

1. A wire puller for easily changing wires, comprising:
a main frame, comprising a stand, a handle connected to the stand, a fixing shaft arranged horizontally between the stand and the handle, and a fixing bracket configured at a side of the fixing shaft;
a take-up wheel, comprising a first half-wheel frame with a sleeve, and a second half-wheel frame correspondingly assembled with the first half-wheel frame, wherein a winding area is defined in an interior between the first half-wheel frame and the second half-wheel frame, and the winding area is provided for accommodating a pull wire, and one end of the pull wire is fixed to the take-up wheel, and wherein the take-up wheel is configured to perform free rotation by sleeving the sleeve on the fixing shaft;
a plurality of fasteners, respectively fixed to the first half-wheel frame and the second half-wheel frame; and
a spring tube, one end of the spring tube passed and fixed to the fixing bracket, an other end of the spring tube provided for an other end of the pull wire being sent out or retracted when the take-up wheel being in free rotation.

2. The wire puller for easily changing wires as claimed in claim 1, wherein the first half-wheel frame comprises a first outer ring and a first inner ring, a diameter of the first inner ring is smaller than that of the first outer ring, the first inner ring is located within a diameter range of the first outer ring, and the first inner ring is arranged on a horizontal plane different from the first outer ring;
wherein the sleeve is connected to a side of a first inner ring and protrudes toward the second half-wheel frame, the sleeve is formed with a protruding block at an end opposite to the first inner ring, and the protruding block, the first inner ring, and the sleeve are communicated in hollow;
wherein the first half-wheel frame further comprises a plurality of first arc-shaped rods between the sleeve and the first outer ring, the plurality of first arc-shaped rods are round rods, one end of each of the plurality of first arc-shaped rods fixed to one end of the sleeve, and an other end of each of the plurality of first arc-shaped rods fixed to the first outer ring;
wherein the second half-wheel frame comprises a second outer ring and a second inner ring, a diameter of the second inner ring is smaller than that of the second outer ring, the second inner ring is located within a diameter range of the second outer ring, and the second inner ring is arranged on a horizontal plane different from the second outer ring; and
wherein the second half-wheel frame further comprises a plurality of second arc-shaped rods between the second inner ring and second outer ring and corresponding to the plurality of first arc-shaped rods, the plurality of second arc-shaped rods are round rods, one end of each of the plurality of second arc-shaped rods fixed to the second inner ring, and an other end of each of the plurality of second arc-shaped rods fixed to the second outer ring.

3. The wire puller for easily changing wires as claimed in claim 2, wherein the first half-wheel frame comprises a first fixing sleeve fixed to one of the plurality of first arc-shaped rods for fixing one end of the pull wire.

4. The wire puller for easily changing wires as claimed in claim 2, wherein the second half-wheel frame comprises a second fixing sleeve and a plurality of buckles, the second fixing sleeve is fixed to the second outer ring for fixing the other end of the pull wire while not being used, and the plurality of buckles are respectively fixed to the second outer ring.

5. The wire puller for easily changing wires as claimed in claim 2, wherein each of the plurality of fasteners comprises a plurality of embedded parts and a guide part, the plurality of embedded parts are arranged on an outer surface of the fastener and spaced apart;
wherein each of the plurality of embedded parts comprises an embedded slot and two fastening bodies respectively protruding from two sides of each of the plurality of embedded parts toward the embedded slot, and one of the plurality of first arc-shaped rods and one of the plurality of second arc-shaped rods are respectively fastened into one of the plurality of embedded parts; and
wherein the guide part is arranged on an inner surface of each of the plurality of fasteners, and the guide part comprises a curved section and two inclined sections respectively extending from the curved section to two ends of each of the plurality of fasteners.

6. The wire puller for easily changing wires as claimed in claim 5, wherein the plurality of fasteners are respectively arranged in different directions to fasten each of the plurality of first arc-shaped rods and each of the plurality of second arc-shaped rods.

7. The wire puller for easily changing wires as claimed in claim 6, wherein the plurality of fasteners are made of plastic material.

8. The wire puller for easily changing wires as claimed in claim 1, wherein the stand comprises two support poles inclined and spaced apart, and a crossbar connected to bottoms of the two support poles;
wherein the fixing shaft comprises a shaft tube, a screw hole configured between the stand and the handle and provided for engagement with one end of the shaft tube, and a fixing rotation piece engaged with the other end of the shaft tube opposite to the screw hole; and
wherein the shaft tube comprises a first outer thread for engaging with the screw hole, and a second outer thread for engaging with an inner thread of the fixing rotation piece.

9. The wire puller for easily changing wires as claimed in claim 8, wherein the fixing shaft comprises two locking members, and each of the two locking members comprises an inner thread for engaging with the second outer thread of the shaft tube, one end of the fixing bracket hung and fixed between the two locking members on the second outer thread of the shaft tube, and an other end of the fixing bracket comprises an annular portion configured obliquely, and the annular portion comprises a through hole.

10. The wire puller for easily changing wires as claimed in claim 9, wherein the annular portion further comprises a first protection washer and a second protection washer assembled with the first protection washer, and wherein the first protection washer is hollow, and one end of the first protection washer passes the through hole to be assembled with the second protection washer.
